(19) United States
(12) Patent Application Publication
(10) Pub. No.: US 2013/0232812 A1
(43) Pub. Date: Sep. 12, 2013

(54) DRYING BOX COMPRISING AT LEAST TWO ZONES FOR DRYING A CELLULOSE PULP WEB

(71) Applicant: Roland Kampris, Farsta (SE)

(72) Inventor: Roland Kampris, Farsta (SE)

(73) Assignee: ANDRITZ TECHNOLOGY AND ASSET MANAGEMENT GMBH, Graz (AT)

(21) Appl. No.: 13/885,571

(22) PCT Filed: Nov. 15, 2011
(86) PCT No.: PCT/SE2011/051367

§ 371 Date: May 15, 2013

(30) Foreign Application Priority Data
Nov. 16, 2010 (SE) 1051200-2

(51) Int. Cl. F26B 13/10

(52) U.S. Cl. CPC F26B 13/10
USPC 34/444; 34/618; 34/621

(57) ABSTRACT

An arrangement for drying a web of cellulose pulp having a drying box which includes blow boxes that are operative for blowing air towards the web of cellulose pulp for drying the pulp in accordance with the airborne web principle. The drying box has a first drying zone, which includes first lower blow boxes arranged to bear the web, and a second drying zone, having second lower blow boxes arranged to bear the web, with the first lower blow boxes being different from the second lower blow boxes.

### FIELD OF THE INVENTION

The present invention relates to an arrangement for drying a web of cellulose pulp in a drying box which comprises blow boxes that are operative for blowing air towards the web of cellulose pulp for drying the pulp in accordance with the airborne web principle.

The present invention further relates to a method of drying a web of cellulose pulp by blowing air towards the web of cellulose pulp by means of blow boxes for drying the pulp in accordance with the airborne web principle.

### BACKGROUND OF THE INVENTION

Cellulose pulp is often dried in a convective type of dryer operating in accordance with the airborne web principle. An example of such a dryer is described in WO 2009/154549. Hot air is blown onto a web of cellulose pulp by means of upper blow boxes and lower blow boxes. The air blown by the blow boxes transfer heat to the web to dry it, and also keeps the web floating above the lower blow boxes. Hot air is supplied to the blow boxes by means of a circulation air system comprising fans and steam radiators heating the drying air.

With increasing demands for increased pulp production in pulp mills, there is a desire to increase the drying capacity of a pulp dryer without increasing its size, or increasing its size only slightly.

### SUMMARY OF THE INVENTION

An object of the present invention is to provide an arrangement for drying a cellulose pulp web, the arrangement being more space efficient than the prior art arrangements.

This object is achieved by means of an arrangement for drying a web of cellulose pulp in a drying box which comprises blow boxes that are operative for blowing air towards the web of cellulose pulp for drying the pulp in accordance with the airborne web principle, wherein the drying box comprises a first drying zone, which comprises first lower blow boxes arranged to bear the web, and a second drying zone, which comprises second lower blow boxes arranged to bear the web, with the first lower blow boxes being different from the second lower blow boxes.

An advantage of this arrangement is that the drying of the pulp web can be optimized in each drying zone to suit the conditions prevailing in that specific zone as regards drying conditions, strength of the web of pulp, etc. Thereby, a sufficient drying capacity can be achieved with a smaller dryer compared to the prior art.

According to one embodiment the first drying zone is arranged upstream of the second drying zone, as seen in the direction of forwarding the web of cellulose pulp. With the drying zones arranged in this order, they may be adapted to the properties, such as web strength, web dryness, etc. that are changed as the web is forwarded through the drying box.

According to one embodiment, at a certain flow of air per square meter of horizontal web area and unit of time, the relative lifting force of the second lower blow boxes is higher than the relative lifting force of the first lower blow boxes, at least for one distance between the respective lower blow box and the web of cellulose pulp. An advantage of this embodiment is that the second lower blow boxes may dry the web at the higher efficiency which is often linked to a higher distance between the web and the respective blow box.

According to one embodiment each drying zone comprises at least four consecutive lower blow boxes.

According to one embodiment, the relative lifting force of the second lower blow boxes is higher than the relative lifting force of the first lower blow boxes at least as long as the distance between the respective lower blow box and the web of cellulose pulp is 2-8 mm. An advantage of this embodiment is that the relative lifting force of the second lower blow boxes is higher than that of the first lower blow boxes in that range of distances between web and lower blow boxes where drying is normally most efficient.

According to one embodiment the first lower blow boxes are provided with inclination type openings adapted to eject at least a portion of the air supplied thereto at an angle to an upper face of the respective blow box. An advantage of this embodiment is that the first lower blow boxes may exert a fixation force to the web, helping to stabilize the web in the first drying zone.

According to one embodiment the drying box comprises a number of drying decks each comprising lower blow boxes and being adapted for drying the web as it travels along a horizontal path at a specific level of the drying box, wherein the first drying zone comprises 10-70% of the total number of drying decks of the drying box. An advantage of this embodiment is that the first drying zone has a suitable length for the web to dry to some extent and to obtain an increased strength, making it less sensitive to increased web tensions that may occur in the second drying zone.

According to one embodiment the first lower blow boxes are provided with inclination type openings which are adapted to eject at least 30% of the air supplied to the first lower blow boxes, and wherein the second lower blow boxes are provided with non-inclined type of openings which are adapted to eject at least 75% of the air supplied to the second lower blow boxes. An advantage of this embodiment is that the first lower blow boxes provide a fixation force to the web, while the second lower blow boxes are highly efficient in drying the web.

According to one embodiment at least 75% of the lower blow boxes of the first drying zone are said first lower blow boxes, and at least 75% of the lower blow boxes of the second drying zone are said second lower blow boxes. An advantage of this embodiment is that the first drying zone becomes efficient in making the web travel along a stable path, and the second drying zone becomes efficient in drying the web.

A further object of the present invention is to provide a method of drying a cellulose pulp web in a more efficient manner than the methods of the prior art.

This object is achieved by means of a method of drying a web of cellulose pulp by blowing air towards the web of cellulose pulp by means of blow boxes for drying the pulp in accordance with the airborne web principle, the method comprising forwarding the web through a first drying zone comprising first lower blow boxes bearing the web, and then forwarding the web through a second drying zone comprising second lower blow boxes bearing the web, the second lower blow boxes being different from the first lower blow boxes.

An advantage of this method is that drying may be made more efficient, and adapted to the different mechanical strength of the web in various positions along the path along which the web is forwarded.

According to one embodiment the average distance between the web and the second lower blow boxes is higher than the average distance between the web and the first lower blow boxes. An advantage of this embodiment is that a higher average distance improves the heat transfer.

According to one embodiment at least 30% of the total air flow supplied to the first lower blow boxes is blown from the first lower blow boxes at an angle of less than 60° to the respective upper faces of those first lower blow boxes, and wherein at least 75% of the total air flow supplied to the second lower blow boxes is blown from the second lower blow boxes at an angle of at least 75° to the respective upper faces of those second lower blow boxes. An advantage of this embodiment is that an efficient fixation of the web is obtained in the first drying zone, while an efficient heat transfer is obtained in the second drying zone.

According to one embodiment the web is forwarded at an average distance of 0.2 to 3 mm above the first lower blow boxes, and at an average distance of 4 to 15 mm above the second lower blow boxes. An advantage of this embodiment is an efficient stabilization of the web by the first lower blow boxes, and an efficient heat transfer to the web of the second lower blow boxes.

Further objects and features of the present invention will be apparent from the description and the claims.

### BRIEF DESCRIPTION OF THE DRAWINGS

The invention will now be described in more detail with reference to the appended drawings in which:

FIG. 1 is a schematic side view, and illustrates a drying box for drying a web of cellulose pulp.

FIG. 2 is a schematic side view, and illustrates the area II of FIG. 1.

FIG. 3 depicts schematic top and cross-sectional views, and illustrates a first lower blow box as seen in the direction of the arrows III-III of FIG. 2.

FIG. 4 is a schematic side view, and illustrates the area IV of FIG. 1.

FIG. 5 is a schematic top view, and illustrates a second lower blow box as seen in the direction of the arrows V-V of FIG. 4.

FIG. 6 is a diagram and illustrates the forces exerted by the first and second lower blow boxes on a pulp web in the vertical direction.

FIG. 7 is a diagram and illustrates the heat transfer of the first and second lower blow boxes.

### DESCRIPTION OF PREFERRED EMBODIMENTS

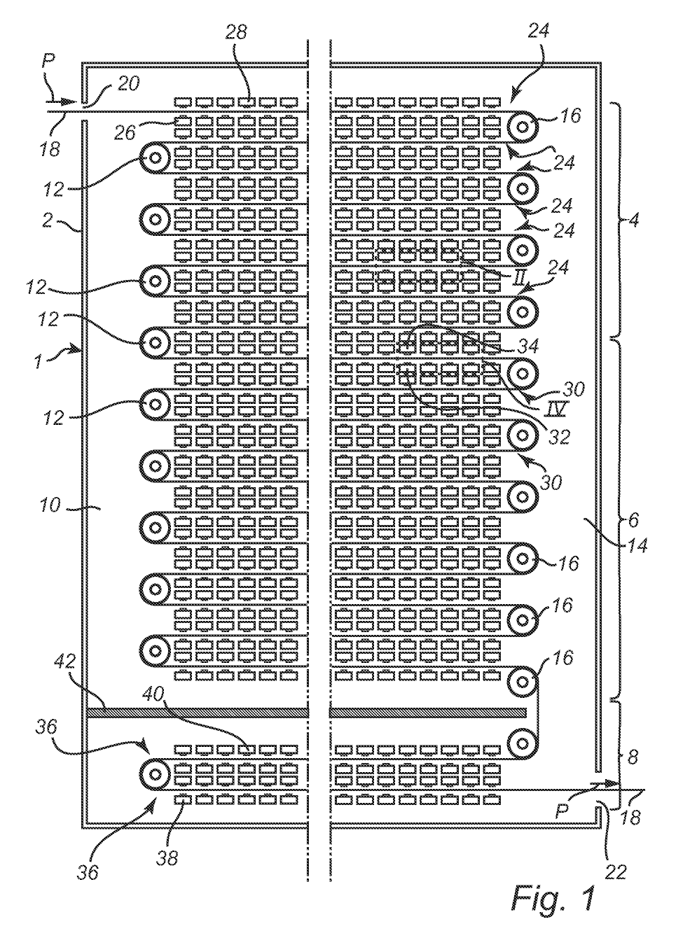

FIG. 1 illustrates a drying box 1 for drying cellulose pulp in accordance with a first embodiment of the present invention. The drying box 1 comprises a housing 2. Inside the housing 2 a first drying zone 4, a second drying zone 6, and an optional cooling zone 8 are arranged, with the first drying zone 4 arranged in the upper region of the housing 2, the cooling zone 8 arranged in the lower region of the housing 2, and the second drying zone 6 being arranged between the first drying zone 4 and the cooling zone 8.

At a first end 10 of the housing 2 a first column of turnings rolls 12 is arranged, and at a second end 14 of the housing 2 a second column of turning rolls 16 is arranged. A wet pulp web 18 enters the drying box 1 via an inlet 20 arranged in the housing 2. In the embodiment of FIG. 1, the inlet 20 is arranged in the upper portion of the housing 2, but the inlet may, in an alternative embodiment, be arranged in the lower portion of the housing. The web 18 is forwarded horizontally, towards the right as illustrated in FIG. 1, in the drying box 1 until the web 18 reaches a turning roll. In the drying box 1 illustrated in FIG. 1, the web 18 will first reach a turning roll 16 of the second column of turning rolls. The web 18 is turned around the turning roll 16, and then travels horizontally towards the left, as illustrated in FIG. 1, in the drying box 1 until the web 18 reaches a turning roll 12 of the first column of turning rolls, at which the web 18 is turned again. In this manner the web 18 travels, in a zigzag manner, from the top to the bottom of the drying box 1, as illustrated by arrows P. The web 18 leaves the drying box 1, after having been dried in the first and second drying zones 4, 6 and having been cooled in the cooling zone 8, via an outlet 22 arranged in the housing 2. In the embodiment of FIG. 1, the outlet 22 is arranged in the lower portion of the housing 2, but the outlet may, in an alternative embodiment, be arranged in the upper portion of the housing.

Typically air of a temperature of 80 to 250° C. is utilized for the drying process. The web 18 of cellulose pulp entering the drying box 1, from an upstream web forming station, not shown in FIG. 1, typically has a dry solids content of 40-60% by weight, and the web 18 of cellulose pulp leaving the drying box 1 has a dry solids content of typically 85-95% by weight. The web 18 of cellulose pulp leaving the drying box 1 typically has a basis weight of 800 to 1500 g/m², when measured at a moisture content of 0.11 kg water per kg dry substance, and a thickness of 0.8 to 3 mm.

The first drying zone 4 comprises at least one first drying deck 24, and typically 3-15 first drying decks 24. In the embodiment of FIG. 1, the first drying zone 4 comprises 8 first drying decks 24. Each such first drying deck 24 comprises a number of blow boxes, as will described in more detail hereinafter, and is operative for drying the web 18 while the web 18 travels horizontally from one turning roll 12, 16 to the next turning roll 16, 12. Each first drying deck 24 comprises a number of first lower blow boxes 26 and a number of first upper blow boxes 28 that are arranged for blowing a hot drying gas towards the cellulose pulp web 18. Typically, each first drying deck 24 comprises 20-300 first lower blow boxes 26 and the same number of first upper blow boxes 28, although in FIG. 1 in the interest of maintaining clarity of illustration only a few blow boxes are illustrated. The first lower blow boxes 26 are operative for keeping the web 18 in a “floating” and fixed condition, such that the web 18 becomes airborne at a distance from the first lower blow boxes 26 during the drying process, as will be described in more detail hereinafter.

The second drying zone 6 comprises at least one second drying deck 30, and typically 5-40 second drying decks 30. In the embodiment of FIG. 1, the second drying zone 6 comprises 11 second drying decks 30. Each such second drying deck 30 comprises a number of blow boxes, as will described in more detail hereinafter, and is operative for drying the web 18 while the web 18 travels horizontally from one turning roll 12, 16 to the next turning roll 16, 12. Each second drying deck 30 comprises a number of second lower blow boxes 32 and a number of second upper blow boxes 34 that are arranged for blowing a hot drying gas towards the cellulose pulp web 18. Typically, each second drying deck 30 comprises 20-300 second lower blow boxes 32 and the same number of second upper blow boxes 34, although in FIG. 1 in the interest of maintaining clarity of illustration only a few blow boxes are illustrated. The second lower blow boxes 32 are operative for keeping the web 18 in a “floating” condition, such that the web 18 becomes airborne at a distance from the second lower blow boxes 32 during the drying process, as will be described in more detail hereinafter.

The first drying decks 24 of the first drying zone 4 have a different mechanical design than the second drying decks 30 of the second drying zone 6, as will be described in more detail hereinafter. Often the first lower blow boxes 26 of the first drying decks 24 would have a different mechanical design than the second lower blow boxes 32 of the second drying decks 30, as will be illustrated by means of an example hereinafter. Each drying zone 4, 6 would typically comprise at least four consecutive respective blow boxes 26, 32. Hence, for example, the first drying zone 4 would typically comprise at least four consecutive first lower blow boxes 26, and the second drying zone 6 would typically comprise at least four consecutive second lower blow boxes 32. Typically each drying zone 4, 6 would comprise at least one complete drying deck 24, 30 including the blow boxes 26, 28, 32, 34 included in the respective drying deck 24, 30.

The cooling zone 8 comprises at least one cooling deck 36, in FIG. 1 two such cooling decks 36 are illustrated, each such deck 36 comprising a number of third lower blow boxes 38 and third upper blow boxes 40 that are arranged for blowing a cooling gas towards the cellulose pulp web 18. The lower blow boxes 38 are operative for keeping the web 18 in a “floating” condition, such that the web 18 becomes airborne during the cooling process. Typically, air of a temperature of 15 to 40° C. is utilized as a cooling gas for the cooling process. An isolated wall 42 separates the second drying zone 6 from the cooling zone 8.

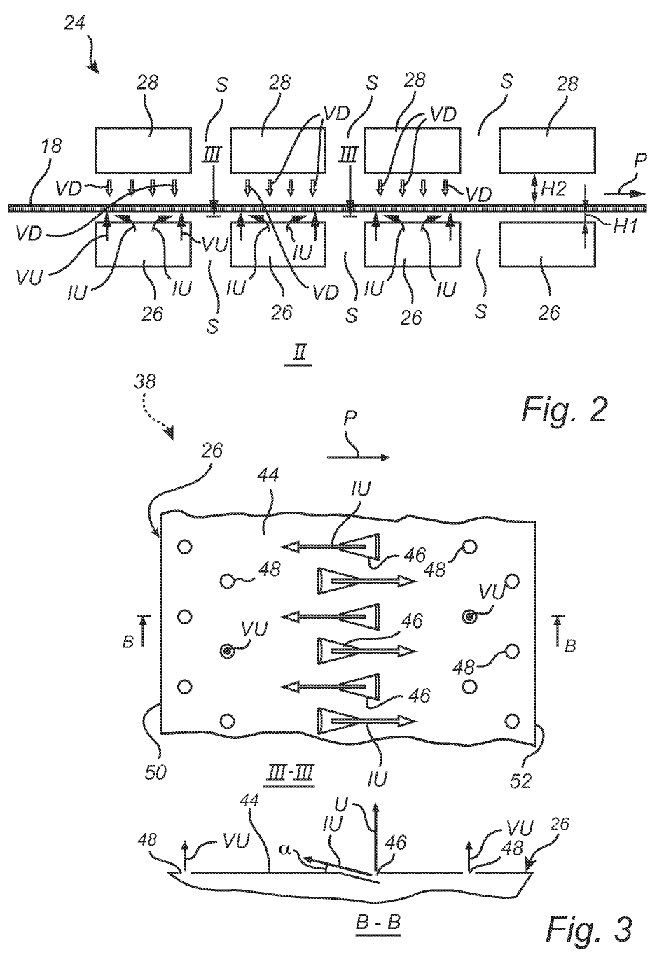

FIG. 2 is an enlarged side view of the area II of FIG. 1 and illustrates a portion of the first drying deck 24 of the first drying zone 4 illustrated in FIG. 1. The first drying deck 24 comprises the first lower blow boxes 26 arranged below the web 18, and the first upper blow boxes 28 arranged above the web 18. The first drying deck 24 may comprise, as illustrated in FIG. 2, at least four consecutive first lower blow boxes 26. Hence, the first drying zone 4 illustrated in FIG. 1 may comprise at least four consecutive first lower blow boxes 26. The first lower blow boxes 26 blow hot drying air towards the web 18 both vertically upwards towards web 18, illustrated by arrows VU in FIG. 2, and in an inclined manner, at an angle of typically 5 to 60° to the horizontal plane, as illustrated by means of arrows IU in FIG. 2. An example of a blow box which may be used as the first lower blow boxes 26 is described in WO 97/16594, see for example FIGS. 2 and 3 of that document. Returning to FIG. 2 of the present application, the blowing of drying air at an inclination to the horizontal plane by the first lower blow boxes 26 yield both forces forcing the web 18 upwards away from the blow boxes 26, and forces forcing the web 18 downwards towards the blow boxes 26. This will result in the blow boxes 26 exerting a fixation force on the web 18, holding the web at a comparably well defined distance from the blow boxes 26. Typically, the average distance, or height H1, between the lower side of the web 18 and the upper surface of the first lower blow boxes 26 is 0.2 to 3 mm during operation of the drying box 1. If the web 18 would tend to move upwards, the fixation forces of the blow boxes 26 would drag the web 18 downwards, and if the web 18 would tend to move downwards, the air blown by the blow boxes 26 would force the web 18 upwards. Hence, the web 18 is transported horizontally along the first drying deck 24 in a relatively fixed manner, with little movement in the vertical direction, meaning that the web 18 is subjected to limited stretching forces. The first type of upper blow boxes 28 blow hot drying air towards the web 18 vertically downwards towards web 18, illustrated by arrows VD in FIG. 2. Typically, the average distance, or height H2, between the upper side of the web 18 and the lower surface of the first upper blow boxes 28 is 10 to 80 mm. The hot drying air blown by the blow boxes 26, 28 is evacuated via gaps S formed between horizontally adjacent blow boxes 26, 28. Often the first drying zone 4 illustrated in FIG. 1 would comprise at least four consecutive first lower blow boxes 26 arranged in the manner illustrated in FIG. 2. Furthermore, the first drying zone 4 illustrated in FIG. 1 would often comprise at least four consecutive first upper blow boxes 28 arranged in the manner illustrated in FIG. 2.

FIG. 3 is a schematic top view, and illustrates the first lower blow box 26 as seen in the direction of the arrows III-III of FIG. 2. An arrow P illustrates the intended path along which the web, not shown in FIG. 3, is to pass over an upper face 44 of the first lower blow box 26. The upper face 44 comprises centrally arranged first type of openings 46, which are “inclination type” openings of a type sometimes referred to as “eyelid perforations”. By “inclination type” openings is meant that at least 25% of the air blown from those openings 46 is blown at an angle α of less than 60° to the upper face 44 of the first lower blow box 26, as is best illustrated in the cross-section B-B of FIG. 3. In the first lower blow box 26 at least 30%, often at least 40%, of the total flow of air supplied thereto is blown from openings of the “inclination type”, for example via eyelid perforations 46. A portion of the flow of air blown via the eyelid perforations 46 may be blown at an angle which is larger than 60°, as indicated by means of an arrow U in the cross-section B-B of FIG. 3. Of the total air flow supplied to the lower blow box 26, at least 30% is blown at an angle α of less than 60° to the upper face 44 of the first lower blow box 26.

The eyelid perforations 46, which may have a similar design as the openings referred to as “eyelid perforations 6” in WO 97/16594, and which are described with reference to FIGS. 2 and 3 of WO 97/16594, provide the hot drying air blown therethrough with an inclination, such that the inclined flows IU illustrated in FIG. 2 of the present application are generated. As can be seen from FIG. 3 of the present application, the perforations 46 are arranged on the face 44 in an alternating manner, such that every second flow IU will be directed to the left, as illustrated in FIG. 3, and every second flow IU will be directed to the right.

Continuing with the description of FIG. 3 of the present application, the upper face 44 is provided with a second type of openings 48, that are arranged close to the sides 50, 52 of the blow box 26. The second type of openings 48 are of a “non-inclined type” that are distributed over the upper face 44. By “non-inclined type” is meant that at least 80% of the air blown from those openings 48 is blown at an angle to the upper surface 44 which is at least 70°. Typically, almost the entire flow of air would be blown almost vertically, i.e., at an angle of close to 90° to the upper surface 44, from the openings 48 of the non-inclined type. The openings 48 may be round holes, with a diameter of typically 1-10 mm. The second type of openings 48 blow the hot drying air upwards to form the flows VU, being directed vertically upwards towards the reader in the illustration of FIG. 3.

By varying the number and size of the first type of openings 46 and the number and size of the second type of openings 48 a suitable pressure-drop relation between first and second types of openings 46, 48 may be achieved, such that, for example, 65% of the total flow of air blown to the first lower blow box 26 is ejected via the first type of openings 46, and 35% of the total flow of air blown to the first lower blow box 26 is ejected via the second type of openings 48.

A degree of perforation of a blow box 26 may be calculated by dividing the total open area of the openings 46, 48 of a representative portion of the upper face 44 by the horizontally projected area of the representative portion of the upper face 44. By “representative portion” is meant a portion of the upper face 44 which is representative with respect to the blowing of air towards the web, i.e. disregarding for example the air inlet part of the blow box. The degree of perforation may, for example, be 1.5%. The degree of perforation can be varied to suit the weight, dryness, etc. of the web 18 to be dried. Often the degree of perforation of the first lower blow box 26 would be 0.5-3.0%.

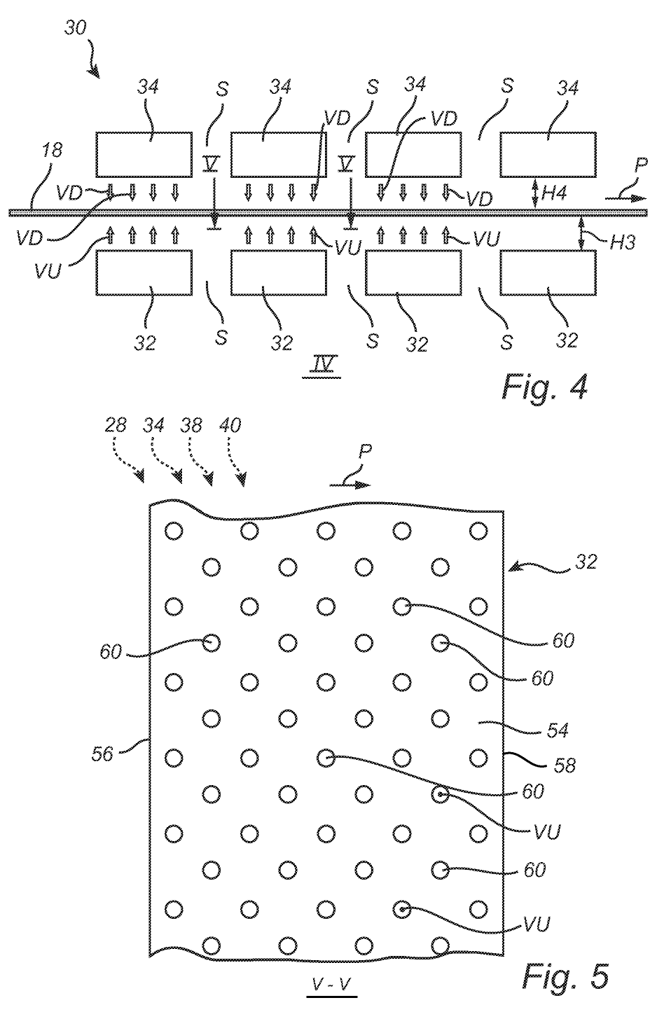

FIG. 4 is an enlarged side view of the area IV of FIG. 1 and illustrates a portion of the second drying deck 30 of the second drying zone 6 illustrated in FIG. 1. The second drying deck 30 comprises the second lower blow boxes 32 arranged below the web 18, and the second upper blow boxes 34 arranged above the web 18. The second drying deck 30 may comprise, as illustrated in FIG. 4, at least four consecutive second lower blow boxes 32. Hence, the second drying zone 6 illustrated in FIG. 1 may comprise at least four consecutive second lower blow boxes 32. The second lower blow boxes 32 blow hot drying air towards the web 18 vertically upwards towards web 18, illustrated by arrows VU in FIG. 4. The second lower blow boxes 32 of the second drying deck 30 exert a lower fixation force on the web 18 compared to the first lower blow boxes 26 of the first drying deck 24, illustrated in FIGS. 2 and 3. The fixation force exerted on the web 18 by the second lower blow boxes 32 is normally rather low, or even non-existing. Returning to FIG. 4, the hot drying air supplied from the second lower blow boxes 32 lifts the web to a height at which the weight of the web 18 is in balance with the lifting force of the hot drying air supplied by the second lower blow boxes 32. Typically, the average distance, or height H3, between the lower side of the web 18 and the upper surface of the second lower blow boxes 32 is 4 to 15 mm. Since there is a limited or even non-existing fixation force exerted by the second lower blow boxes 32 on the web 18, the vertical position of the web 18 will tend to fluctuate, during operation of the drying box 1, somewhat more when passing the second drying decks 30, compared to when passing the first drying decks 24. Hence, the web 18 is transported horizontally along the second drying deck 30 in a relatively free manner, with some movement in the vertical direction, meaning that the web 18 is subjected to some stretching forces. The second type of upper blow boxes 34 blow hot drying air towards the web 18 vertically downwards towards web 18, illustrated by arrows VD in FIG. 4. Typically, the average distance, or height H4, between the upper side of the web 18 and the lower surface of the second upper blow boxes 34 is 5 to 80 mm. The hot drying air blown by the blow boxes 32, 34 is evacuated via gaps S formed between horizontally adjacent blow boxes 32, 34. Often the second drying zone 6 illustrated in FIG. 1 would comprise at least four consecutive second lower blow boxes 32 arranged in the manner illustrated in FIG. 4. Furthermore, the second drying zone 6 illustrated in FIG. 1 would often comprise at least four consecutive second upper blow boxes 34 arranged in the manner illustrated in FIG. 4.

FIG. 5 is a schematic top view, and illustrates the second lower blow box 32 as seen in the direction of the arrows V-V of FIG. 4. An arrow P illustrates the intended path along which the web, not shown in FIG. 5, is to pass over an upper face 54 of the second lower blow box 32. The upper face 54 extends between the sides 56, 58 of the blow box 32 and comprises openings 60 of the “non-inclined type” that are distributed over the upper face 54. By “non-inclined type” is, in accordance with the previous definition, meant that at least 80% of the air blown from those openings 60 is blown at an angle to the upper face 54 which is at least 70°. Typically, almost the entire flow of air would be blown almost vertically, i.e., at an angle of close to 90° to the upper face 54, from the openings 60 of the non-inclined type. In the second lower blow box 32 at least 75% of the total flow of air supplied thereto is blown from openings of the non-inclined type. In the embodiment illustrated in FIG. 5, 100% of the total flow of air supplied thereto is blown from the openings 60 of the non-inclined type. The openings 60 may be evenly distributed over the face 54, but may also be distributed in an uneven manner. As can be seen from FIG. 5, the concentration of openings 60 (openings per square centimetre of upper face 54) is somewhat higher adjacent to the sides 56, 58. The openings 60 of the blow box 32 may be round holes, with a diameter of typically 1-10 mm. The openings 60 blow the hot drying air vertically upwards to form the flows VU, being directed vertically upwards towards the reader in the illustration of FIG. 5.

The degree of perforation, by which is meant the total area of the openings 60 divided by the total area of the upper face 54, may, for example, be 1.5%. The degree of perforation can be varied to suit the weight, dryness, etc. of the web 18 to be dried. Often the degree of perforation of the second lower blow box 32 would be 0.5-3.0%.

The first upper blow boxes 28 of the first drying decks 24, illustrated in FIG. 2, and the second upper blow boxes 34 of the second drying decks 30, illustrated in FIG. 4, may typically have the same general design as the second lower box 32 illustrated in FIG. 5, as indicated by dashed arrows in FIG. 5. Hence, the first upper blow boxes 28 and the second upper blow boxes 34 may typically be provided with openings which may be round holes, with a diameter of 1-10 mm.

Furthermore, the third lower blow boxes 38 and the third upper blow boxes 40 of the cooling zone 8 may also have a similar design as the second lower blow boxes 32 illustrated in FIG. 5, as illustrated by means of dashed arrows. In accordance with an alternative embodiment, the third lower blow boxes 38 may have a similar design as the first lower blow boxes 26 illustrated in FIG. 3, as illustrated by means of a dashed arrow.

The above mentioned average distances H1, H2, H3, H4, all refer to the shortest distance between the face 44, 54 of the respective blow box 26, 28, 32, 34 and the web 18.

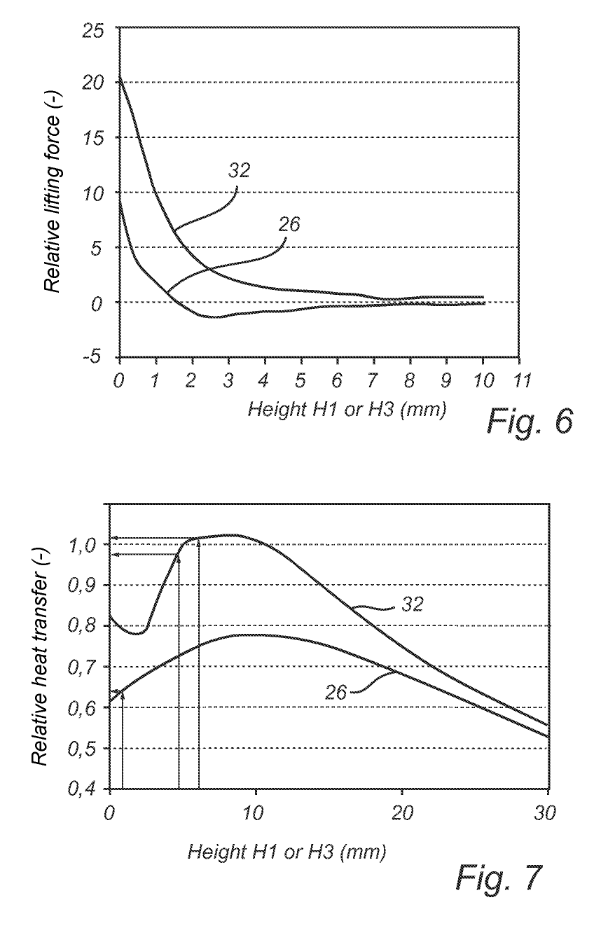

FIG. 6 is a diagram and illustrates schematically an example of the forces exerted on the web 18 in the vertical direction by the first lower blow boxes 26 of the first drying decks 24 and by the second lower blow boxes 32 of the second drying decks 30. The average distance, or height H1 and H3, illustrated in FIGS. 2 and 4, between the lower side of the web 18 and the upper face 44, 54 of the respective blow box 26, 32 depends on the balance between the basis weight of the web 18 and the lifting force exerted by the respective blow boxes 26, 32 on the web 18. The lifting force depends on the average distance between the lower side of the web 18 and the upper face 44, 54 of the respective blow box 26, 32. At that average distance at which the lifting force is equal to the basis weight of the web, the lifting force generated by the air blown by the blow boxes 26, 32 will bear the web, with the web “floating” in a stable manner. Hence, the average distance between the lower side of the web 18, when “floating” in a stable manner, and the upper face 44, 54 of the respective blow box 26, 32 will vary with the basis weight of the web.

The relation between basis weight on the one hand, and average distance, or height H1 and H3, between the lower side of the web 18 and the upper face 44, 54 of the respective blow box 26, 32 on the other hand can be illustrated by looking at a model web which can have various dry solids contents. The model web has a relative basis weight of 1.0 at 100% by weight dry solids content. The model web would, upon entering the dryer, have a dry solids content of only 50% by weight, meaning that the relative basis weight of the model web upon entering the dryer would be 2.0 since the web would contain, in addition to the dry solids content, also water. Hence, the more water, the larger the relative basis weight of the model web. A relative lifting force of 1.0 is defined as that lifting force which would be required to keep the model web, at its relative basis weight of 1.0 at 100% by weight dry solids content, floating in a stable manner above the first and second lower blow boxes 26, 32, respectively.

In FIG. 6, the Y-axis indicates the relative lifting force, and the X-axis indicates the average distance, or height H1, and H3, respectively, between the lower side of the web 18 and the upper face 44, 54 of the respective blow box 26, 32. Curve “26” indicates the relation between relative lifting force and average distance H1 for the first lower blow boxes 26, and curve “32” indicates the relation between relative lifting force and average distance H3 for the second lower blow boxes 32. Returning to the definition of the relative lifting force, it can be seen from curve “26” that a relative lifting force of 1.0 would correspond to an average distance H1 of about 1.3 mm. Hence, if the above mentioned model web, having a relative basis weight of 1.0 at 100% by weight dry solids content, would be exposed to a relative lifting force of 1.0, it would “float” in a stable manner at an average distance H1 of 1.3 mm above the first lower blow boxes 26. At a dry solids content of 50% by weight, the model web has a relative basis weight of 2.0. To make such a web “float” in a stable manner, a relative lifting force of 2.0 would be needed. Looking at curve “26” again, the average distance H1 of about 0.8 mm can be found to correspond to a relative lifting force of 2.0.

Typically, the flow of air per square meter of horizontal web area and unit of time supplied by the blow boxes 26, 32 would correspond to 500 to 2000 m³/(m², h). This flow is the flow that actually is forwarded towards the web 18. The gaps S formed between the blow boxes are included in the calculation of the web area, meaning that the flow from the face of each blow box, disregarding the gaps S, would typically be 10-25% higher.

In accordance with one example, the model web would, when passing through the first drying zone 4, typically have a dry solids content increasing from initially 50% by weight, corresponding to a relative basis weight of 2.0, to about 70% by weight, corresponding to a relative basis weight of 1.4, at the end of the first drying zone 4 as an effect of moisture being dried off from the web 18. Looking at the curve “26” for the first lower blow boxes 26 of FIG. 6, it is clear that a relative lifting force of 2.0 would correspond to a height H1 of about 0.8 mm. Hence, the equilibrium distance H1 between the model web 18 and the first lower blow boxes 26 adjacent to the beginning of the first drying zone 4 is about 0.8 mm, since at such a distance H1 the relative basis weight of the web 18 is in balance with the relative lifting force of the lower blow boxes 26. If the web 18 would temporarily move away from the first lower blow boxes 26, for example to a distance H1 of 2 mm, the first lower blow boxes 26 will exert a negative relative lifting force, i.e., a relative fixation force, of about −0.5, which will drag the web 18 downwards. If the web 18 would temporarily move down towards the first lower blow boxes 26, for example to a distance H1 of 0.5 mm, the first lower blow boxes 26 will exert a positive relative lifting force of about 3.5, which will force the web 18 upwards. Hence, the web 18 is fixed at the equilibrium distance H1, and cannot easily move away from that equilibrium distance, since lifting or fixation forces will bring the web back to the equilibrium distance. At the end of the first drying zone 4 the equilibrium distance H1, at which the relative basis weight of 1.4 is balanced by a relative lifting force of 1.4, would be about 1.1 mm.

Furthermore, continuing with the above example, the web 18 would, when passing through the second drying zone 6, typically have a dry solids content increasing from initially 70% by weight, corresponding to a relative basis weight of 1.4, to about 90% by weight, corresponding to a relative basis weight of 1.1, at the end of the second drying zone 6 as an effect of moisture being dried off from the web 18. Looking at the curve “32” for the second lower blow boxes 32 of FIG. 6, it is clear that a relative lifting force of 1.4, which would be in balance with the relative basis weight of 1.4, would correspond to a height H3 of about 4.5 mm. Hence, the equilibrium distance H3 between the web 18 and the second lower blow boxes 32 adjacent to the beginning of the second drying zone 6 is about 4.5 mm. If the web 18 would temporarily move up and away from the second lower blow boxes 32, for example to a distance H3 of 6.5 mm, only a small reduction in the relative lifting force, to about 1.0, would result, meaning that the web 18 is made to descend downwards until a sufficient relative lifting force corresponding to the relative basis weight is reached. If the web 18 would temporarily move down towards the second lower blow boxes 32, for example to a distance H3 of 3 mm, the second lower blow boxes 32 will exert a positive relative lifting force corresponding to about 2.5, which will force the web 18 upwards. Hence, the web 18 “floats” at the equilibrium distance H3, but minor fluctuations from the equilibrium distance would result in rather moderate forces bringing the web 18 back to its equilibrium distance H3. At the end of the second drying zone 6 the equilibrium distance H3, at which the relative basis weight of 1.1 is balanced by a relative lifting force of 1.1, would be about 6.0 mm.

FIG. 7 is a diagram and illustrates the relative heat transfer between the web 18 and the first lower blow boxes 26 of the first drying decks 24, and by the second lower blow boxes 32 of the second drying decks 30, respectively. On the horizontal axis, the X-axis, the average distance, or height H1, and H3, respectively, between the lower side of the web 18 and the upper face 44, 54 of the respective blow box 26, 32 is indicated. On the vertical axis, the Y-axis, the relative heat transfer from the respective blow box 26, 32 to the web 18 is indicated. The relative heat transfer is 1.0 at an average distance H3 of 5 mm of the second lower blow boxes 32, and all other relative heat transfer values are calculated in relation to that heat transfer.

Continuing with the example given in conjunction with FIG. 6, it may be recalled that the equilibrium distance H1 between the web 18 and the first lower blow boxes 26 of the first drying zone 4 was about 0.8 mm at the beginning of that zone 4, and about 1.1 mm at the end of that zone 4. Looking at the curve “26” for the first lower blow boxes 26 of FIG. 7, it is clear that a relative heat transfer of about 0.63 would correspond to a height H1 of 0.8 to 1.1 mm. Furthermore, it may be recalled from the example given in conjunction with FIG. 6 that the equilibrium distance H3 between the web 18 and the second lower blow boxes 32 of the second drying zone 6 was about 4.5 mm at the beginning of that zone 6, and about 6.0 mm at the end of that zone 6. Looking at the curve “32” for the second lower blow boxes 32 of FIG. 7, it is clear that a relative heat transfer of about 0.98 would correspond to a height H3 of about 4.5 mm, being the typical conditions at the beginning of the second drying zone 6, and that a relative heat transfer of about 1.01 would correspond to a height H3 of about 6.0 mm, being the typical conditions at the end of the second drying zone 6.

From FIG. 7 and the above example, it is clear that the heat transfer of the second drying zone 6 is considerably higher than that of the first drying zone 4. Without being bound by any theory, it would seem as if the better heat transfer of the second drying zone 6 is attributed both to the fact that a longer distance between the web 18 and the respective blow box 26, 32 is beneficial to the heat transfer, at least up to about 10 mm distance, and to the fact that the second lower blow boxes 32, with the hot drying air being blown predominantly in a vertical direction VU upwards towards the web 18, appear to be, as such, more efficient than the first lower blow boxes 26, blowing some of the hot drying air in an inclined manner. The first drying zone 4, on the other hand, provides a more stable control of the forwarding of the web 18, resulting in less stretching forces being exerted on the web 18. The tensile strength of the web 18 tends to increase with decreasing moisture content. Hence, the web 18 is comparably weak adjacent to the inlet 20 of the drying box 1, illustrated in FIG. 1, and is comparably strong adjacent to the outlet 22 of the drying box 1. In the first drying zone 4 the web is, hence, dried under low stretching conditions, with a quite stable path of the web, until the web has been dried to, for example, a dry solids content of about 55-80%. Then, with the web 18 having obtained a higher tensile strength, the web 18 is dried in the second drying zone 6 at conditions of increased stretching, but also with a very high heat transfer, making the drying efficient.

Hereinbefore it has been described, with reference to FIG. 1, that the drying box 1 comprises a first drying zone 4, a second drying zone 6, and a cooling zone 8. It will be appreciated that many alternative embodiments are possible. For example, it is also possible to design a drying box having a first drying zone 4, and a second drying zone 6, but no cooling zone, in the event that cooling is not required.

As described hereinbefore, the third lower blow boxes 38 of the cooling zone 8 may have the same general design as the first lower blow boxes 26 illustrated in FIG. 3, or the same general design as the second lower blow boxes 32 illustrated in FIG. 5.

Utilizing third lower blow boxes 38 having the same general design as the second lower blow boxes 32 as illustrated in FIG. 5 has the advantage that the heat transfer will be high, similar to the heat transfer illustrated for the second lower blow box 32 illustrated and described in conjunction with FIG. 7. Hence, the cooling in the cooling zone 8 becomes very efficient.

Utilizing third lower blow boxes 38 having the same general design as the first lower blow boxes 26 as illustrated in FIG. 3 has the advantage that the web 18 leaving the drying box 1 via the outlet 22 is stabilized, with little vertical movement. This may be an advantage to downstream equipment, such as a web position control unit, a web cutter etc. that handle the dried web 18 leaving the drying box 1.

Hence, if heat transfer has the highest priority in the cooling zone 8, then it would be suitable to utilize as the third lower blow boxes 38 a design of the general type disclosed in FIG. 5. If, on the other hand, web stability has the highest priority in the cooling zone 8, then it would be suitable to utilize as the third lower blow boxes 38 a design of the general type disclosed in FIG. 3. A further option is to arrange a cooling zone 8 which has one or more cooling decks 36 having lower blow boxes 38 of the design illustrated in FIG. 5 to obtain efficient cooling, with such a cooling zone 8 having a last cooling deck 36, just upstream of the outlet 22 of the drying box 1, which is provided with third lower blow boxes 38 of a design of the general type disclosed in FIG. 3 to obtain good web stability just before the web 18 leaves the drying box 1. If web stability has the highest priority, but the drying box has no cooling zone, then a third drying zone could be arranged downstream of the second drying zone. Such a third drying zone would typically have drying decks that would resemble the first drying decks 24 of the first drying zone 4, and have first lower blow boxes 26 that would yield high web stability. Such a third drying zone would typically have just one to four drying decks.

It will be appreciated that numerous variants of the above described embodiments are possible within the scope of the appended claims.

Hereinbefore it has been described that the drying box 1 has totally 19 drying decks. Of these drying decks 8 (42% of the total number of drying decks) belong to the first drying zone 4, and 11 (58% of the total number of drying decks) belong to the second drying zone 6. In a drying box having two drying zones 4, 6 typically 10-70% of the total number of drying decks would belong to the first drying zone 4 and be provided with first lower blow boxes 26 of the type illustrated in FIG. 3, and, correspondingly, typically 30-90% of the total number of drying decks would belong to the second drying zone 6 and be provided with second lower blow boxes 32 of the type illustrated in FIG. 5. Normally, the first drying zone 4 would only have that many drying decks that are required for the web 18 to obtain a tensile strength being sufficient for the second drying zone 6. In case there is a third, and even fourth drying zone, those would normally reduce the number of drying decks of the second drying zone. Typically the first drying zone 4 would comprise at least two first drying decks 24.

Hereinbefore, it has been described that the first lower blow boxes 26 would be provided with inclination type openings 46 of the “eyelid perforation” type disclosed in WO 97/16594. It will be appreciated that the inclination type openings 46 may also have an alternative design. An example of such an alternative design is disclosed in U.S. Pat. No. 5,471,766. In FIG. 6 of U.S. Pat. No. 5,471,766 a blow box is disclosed which has a central V-shaped groove in its upper face. On the side walls of the groove holes have been formed, such holes being inclined to the upper face of the blow box. Inclination type openings of this “groove wall perforation” type may be utilized for the first lower blow boxes as inclination type openings.

It will be appreciated that different types of fixation type of blow boxes could be utilized in the drying box. Hence, a first drying zone could be provided with first lower blow boxes 26 of the type illustrated in FIG. 3. Hence, in the first drying zone a comparably large fixation force would be at hand. A second drying zone could be provided with first lower blow boxes being similar to the type illustrated in FIG. 3, but having a lower fixation force. Such lower fixation force could be achieved, for example, by increasing the diameter and/or the number of the second type of openings 48, such that less drying air passes through the eyelid perforations 46. This would yield a lower fixation force, which may still be acceptable, since the web has already gained an increased tensile strength in the first drying zone. Then a third drying zone commences, such third drying zone having drying decks and second lower blow boxes of the type illustrated in FIGS. 4 and 5. Hence, the different types of blow boxes can be arranged in various ways to obtain suitable conditions with regard to the fixation force and the heat transfer for the particular web 18 that is to be dried in the drying box 1. Thus, a drying box could be provided with two or more drying zones, typically 2 to 10 drying zones.

In FIG. 4 it has been illustrated that each upper blow box 34 is arranged vertically above a respective lower blow box 32. It will be appreciated that other arrangements of upper and lower blow boxes could also be utilized. One example of such an alternative arrangement is a so-called staggered arrangement in which each upper blow box 34 is centred above the gap S between two adjacent lower blow boxes 32.

Hereinbefore it has been described that the openings 48, 60 are round holes. It will be appreciated that other shapes than round holes are also possible for use as openings. For example, the openings 48, 60 could be given the shape of a square, a rectangle, a triangle, an oval, a pentagon, a hexagon, etc.

Hereinbefore it has been described that the first drying zone 4 comprises first lower blow boxes 26, and that the second drying zone 6 comprises second lower blow boxes 32. It will be appreciated that mixing of blow boxes in the respective drying zone is possible. Hence, the first drying zone 4 could, for example, comprise up to 25% second lower blow boxes 32, and the second drying zone 6 could comprise up to 25% first lower blow boxes 26. Also other types of lower blow boxes could be comprised in the first and second drying zones. Preferably, in the first drying zone 4, at least 75% of the lower blow boxes should be first lower blow boxes 26, and in the second drying zone 6, at least 75% of the lower blow boxes should be second lower blow boxes 32. In accordance with one embodiment a drying deck could comprise respective lower blow boxes and upper blow boxes of one type only. Hence, for example, at least one of the first drying decks 24 of the first drying zone 4 could comprise solely first lower blow boxes 26 and first upper blow boxes 28, and at least one of the second drying decks 30 of the second drying zone 6 could comprise solely second lower blow boxes 32 and second upper blow boxes 34. It is also possible that, for example, a first portion of a drying deck comprises first lower blow boxes 26, and that a subsequent second portion of such drying deck comprises second lower blow boxes 32. In such case, such first portion of the drying deck may belong to a first drying zone 4, and such subsequent second portion of the drying deck may belong to a second drying zone 6.

1. Arrangement for drying a web of cellulose pulp in a drying box which comprises blow boxes that are operative for blowing air towards the web of cellulose pulp for drying the pulp in accordance with the airborne web principle, wherein the drying box comprising a first drying zone, which comprises first lower blow boxes arranged to bear the web, and a second drying zone, which comprises second lower blow boxes arranged to bear the web, with the first lower blow boxes being of a different design than the second lower blow boxes, such that drying of the pulp web in the respective drying zone suits the conditions prevailing in that specific zone.

2. Arrangement according to claim 1, wherein the first drying zone is arranged upstream of the second drying zone, as seen in the direction of forwarding the web of cellulose pulp.

3. Arrangement according to claim 1, wherein the relative lifting force of the second lower blow boxes is higher than the relative lifting force of the first lower blow boxes, at least for one distance between the respective lower blow box and the web of cellulose pulp.

4. Arrangement according to claim 3, wherein the relative lifting force of the second lower blow boxes is higher than the relative lifting force of the first lower blow boxes at least as long as the distance between the respective lower blow box and the web of cellulose pulp is 2-8 mm.

5. Arrangement according to claim 1, wherein the first lower blow boxes are provided with inclination type openings adapted to eject at least a portion of the air supplied thereto at an angle to an upper face of the respective blow box.

6. Arrangement according to claim 1, wherein the drying box comprises a number of drying decks each comprising lower blow boxes and being adapted for drying the web as it travels along a horizontal path at a specific level of the drying box, wherein the first drying zone comprises 10-70% of the total number of drying decks of the drying box.

7. Arrangement according to claim 1, wherein the first lower blow boxes are provided with inclination type openings which are adapted to eject at least 30% of the air supplied to the first lower blow boxes, and wherein the second lower blow boxes are provided with non-inclined type of openings which are adapted to eject at least 75% of the air supplied to the second lower blow boxes.

8. Arrangement according to claim 1, wherein at least 75% of the lower blow boxes of the first drying zone are said first lower blow boxes, and at least 75% of the lower blow boxes of the second drying zone are said second lower blow boxes.

9. Arrangement according to claim 1, wherein the drying box further comprises a cooling zone arranged downstream of the second drying zone, the cooling zone comprising said first lower blow boxes.

10. A method of drying a web of cellulose pulp by blowing air towards the web of cellulose pulp by means of blow boxes for drying the pulp in accordance with the airborne web principle, wherein the method comprises
forwarding the web through a first drying zone comprising first lower blow boxes bearing the web, and then
forwarding the web through a second drying zone comprising second lower blow boxes bearing the web, the second lower blow boxes being of a different design than the first lower blow boxes, such that drying of the pulp web in the respective drying zone suits the conditions prevailing in that specific zone.

11. The method according to claim 10, wherein the average distance between the web and the second lower blow boxes is higher than the average distance between the web and the first lower blow boxes.

12. The method according to claim 10, wherein the second lower blow boxes exert a higher heat transfer to the web than the first lower blow boxes.

13. The method according to claim 10, wherein at least 30% of the air supplied to the first lower blow boxes is blown from the first lower blow boxes via inclination type openings, and wherein at least 75% of the air supplied to the second lower blow boxes is blown from the second lower blow boxes via non-inclined type openings.

14. The method according to claim 10, wherein at least 30% of the total air flow supplied to the first lower blow boxes is blown from the first lower blow boxes at an angle (α) of less than 60° to the respective upper faces of those first lower blow boxes, and wherein at least 75% of the total air flow supplied to the second lower blow boxes is blown from the second lower blow boxes at an angle of at least 75° to the respective upper faces of those second lower blow boxes.

15. The method according to claim 10, wherein the web is forwarded at an average distance of 0.2 to 3 mm above the first lower blow boxes, and at an average distance of 4 to 15 mm above the second lower blow boxes.
